(19) United States
(12) Patent Application Publication
(10) Pub. No.: US 2024/0286893 A1
(43) Pub. Date: Aug. 29, 2024

(54) PROCESS AND SYSTEM FOR PRODUCING A GAS COMPRISING NITROGEN (N2) AND HYDROGEN (H2) BY COMBUSTION OF HYDROGEN IN THE PRESENCE OF AIR

(71) Applicant: HYDRO-QUÉBEC, Montréal (CA)

(72) Inventors: Raynald LABRECQUE, Shawinigan (CA); Michel VIENNEAU, Saint-Hubert (CA); Germain LAROCQUE, Beloeil (CA); Ali SHEKARI, Côte-St-Luc (CA)

(21) Appl. No.: 18/552,490

(22) PCT Filed: Mar. 25, 2022
(86) PCT No.: PCT/CA2022/050444

§ 371 Date: Sep. 26, 2023

(30) Foreign Application Priority Data
Mar. 26, 2021 (CA) 3113341

(51) Int. Cl. C01B 3/02

(52) U.S. Cl. CPC C01B 3/02; C01B 2203/068; C01B 2203/0816; C01B 2203/1623

(57) ABSTRACT

The technology relates to a process and system for producing a gas comprising nitrogen (N₂) and hydrogen (H₂) in a reaction chamber of length L of a reactor. The process comprises injecting air and injecting hydrogen into the reactor and the combustion of a portion of the injected hydrogen with the oxygen from the air in the reaction chamber, in the presence of an overstoichiometric molar excess of hydrogen relative to the oxygen from the air. The combustion is supported by a flame produced by an air flow having a velocity v₁ resulting from the injection of air, surrounded by a hydrogen flow having a velocity v₂ resulting from the injection of hydrogen, with the velocity v₂ being greater than v₁.

### TECHNICAL FIELD

The present application relates to a process and a system for producing a gas comprising nitrogen (N₂) and hydrogen (H₂) by combustion of hydrogen in the presence of air. More particularly, the process and the system can allow producing a synthesis gas based on N₂ and H₂ that can be used to produce ammonia.

### STATE OF THE ART

Ammonia is a base product that is central to the production of a wide range of chemical products. In addition, its potential use as a fuel—or an energy vector—is currently being considered. Ammonia can be produced by the well-known Haber-Bosch process, which is based on the following reaction:

N₂+3 H₂→2 NH₃ (1)

To carry out this reaction, one requires nitrogen and hydrogen in a H₂/N₂ molar ratio of 3. The mixture of nitrogen and hydrogen required for the reaction constitutes what is called a synthesis gas.

The hydrogen required to generate synthesis gas can be produced in a variety of ways. In the context of sustainable development, this hydrogen can be produced by means of water electrolysis systems with a renewable electricity supply (e.g., hydraulic, wind, solar).

On the other hand, the nitrogen required to constitute the synthesis gas comes from air, which contains around 79% nitrogen and 21% oxygen. Various approaches are already being used to produce nitrogen from air. Among others, nitrogen can be produced by cryogenics, membrane separation or physical adsorption (Pressure Swing Adsorption or “PSA”).

An alternative approach to producing nitrogen consists in reacting the oxygen from the air, in the presence of hydrogen, so as to transform this oxygen into water vapor according to the reaction

½O₂+H₂→H₂O (2)

Hydrogen in a sufficient amount can be burned to completely convert, into water vapor, the oxygen in the air. Then, this water vapor can be separated, for example by condensation, to thus recover the nitrogen.

To produce synthesis gas intended for ammonia production, one can use an electrolysis system that can produce both the hydrogen required for ammonia synthesis and the amount of hydrogen that needs to be burned to transform into water vapor the oxygen in the air used to produce the nitrogen required for ammonia synthesis.

However, the combustion of hydrogen in the presence of air results in the formation of nitrogen oxides (NOx) that are oxidizing molecules which can interact with the catalyst, generally iron-based, used for ammonia synthesis. The synthesis gas used to produce ammonia must therefore contain no significant quantities of NOx.

Of particular interest is a process for producing a gas based on hydrogen and nitrogen, useful for ammonia synthesis for example, by combustion of hydrogen in the presence of air. A process to produce a gas based on hydrogen and nitrogen, by simple combustion of hydrogen in the presence of air, which can be implemented in a reactor of simple design, while allowing limiting NOx formation is attractive. Such a process will be described in the following.

### SUMMARY

According to a first aspect, the present technology relates to a process for producing a gas comprising nitrogen (N₂) and hydrogen (H₂) in a reaction chamber of length L of a reactor, comprising injecting air and injecting hydrogen into the reactor and combusting a portion of the injected hydrogen with the oxygen from the air in the reaction chamber in the presence of an overstoichiometric molar excess of hydrogen relative to the oxygen from the air, wherein:
the combustion is supported by a flame produced by an air flow having a velocity v₁ resulting from the injection of air, surrounded by a hydrogen flow having a velocity v₂ resulting from the injection of hydrogen, with the velocity v₂ being greater than v₁.

According to one embodiment, the process is such that the velocity v₁ is from about 1 m/s to about 200 m/s. According to another embodiment, the velocity v₁ can be from about 5 m/s to about 150 m/s. The velocity v₁ can also be from about 10 m/s to about 100 m/s.

According to another embodiment, the process is such that the velocity v₂ is from about 2 m/s to about 220 m/s. According to another embodiment, the velocity v₂ can be from about 10 m/s to about 200 m/s. The velocity v₂ can also be from about 15 m/s to about 175 m/s.

According to another embodiment, the process is such that air is injected with a molar flow rate F₁, hydrogen is injected with a molar flow rate F₂, and the ratio F₁/F₂ is comprised between about 1.2 and about 3.5. According to another embodiment, the ratio F₂/F₁ can be comprised between about 2 and about 3.5. The ratio F₂/F₁ can also be comprised between about 2.8 and about 3.5.

According to another embodiment, the process is such that the length L of the reaction chamber is such that the reaction chamber volume allows a minimal residence time of air and hydrogen, inside the reaction chamber. According to another embodiment, the residence time can be from 0.001 to 1 second. The residence time can also be from 0.01 to 0.1 second.

According to another embodiment, the process is such that the reaction chamber is maintained at an average temperature T comprised between about 500° C. and about 1500° C. during the combustion.

According to another embodiment, the process is such that the reaction chamber is maintained at a temperature T₁ in a first region where the flows of air and hydrogen mix in the reaction chamber, with T₁ comprised between about 600° C. and about 1500° C.

According to another embodiment, the process is such that the reaction chamber is maintained at a temperature T₂ in a second region near an outlet of the reaction chamber, with T₂ comprised between about 500° C. and about 1500° C. The temperature T₂ can also be comprised between about 500° C. and about 1200° C.

According to another embodiment, the process is such that the temperature is maintained in the reaction chamber at least in part by dissipating heat generated by the flame to the outside of the reaction chamber.

According to another embodiment, the process is such that the temperature is maintained in the reaction chamber at least in part by recovery of heat generated by the flame, by a heat transfer fluid. The heat transfer fluid can be a liquid, an oil or a gas. The heat transfer fluid can also be water of suitable quality for generating superheated steam. According to one embodiment, the generated steam can be recycled to provide at least in part the heat required in the process or in another process or to generate electricity. According to one embodiment, the dissipation of heat can be performed by convection, in the presence of air.

According to another embodiment, the process is such that the pressure in the reaction chamber is at least 1 atm. According to another embodiment, the pressure in the reaction chamber can be from 1 atm to about 10 atm.

According to another embodiment, the process is such that hydrogen comes from a water electrolysis reaction.

According to another embodiment, the process further comprises drying the gas comprising nitrogen (N₂) and hydrogen (H₂) produced, and recovering water. According to one embodiment, drying can comprise cooling condensation.

According to another aspect, the present technology concerns the use of a gas comprising nitrogen (N₂) and hydrogen (H₂) produced by the process as defined in the present description, for the synthesis of ammonia.

According to another aspect, the present technology concerns a system comprising at least one reactor to produce a gas comprising nitrogen (N₂) and hydrogen (H₂), wherein said reactor comprises:
a reaction chamber comprising a wall and a first end and a second end separated by a distance L, wherein the gas is produced by combusting a portion of injected hydrogen with oxygen from air in the presence of an overstoichiometric molar excess of hydrogen relative to the oxygen from the air;
at least one first means for supplying the reaction chamber with an air flow at a velocity v₁ at the first end of the chamber;
at least one second means for supplying the reaction chamber with a hydrogen flow at a velocity v₂ at the first end of the chamber, the velocity v₂ being greater than v₁;
the first means supplying the air flow and the second means supplying the hydrogen flow are arranged so that the air flow is surrounded by the hydrogen flow during the combustion.

According to one embodiment, the system is such that the velocity v₁ is from about 1 m/s to about 200 m/s. According to another embodiment, the velocity v₁ can be from about 5 m/s to about 150 m/s. The velocity v₁ can also be from about 20 m/s to about 100 m/s.

According to another embodiment, the system is such that the velocity v₂ is from about 2 m/s to about 220 m/s. According to another embodiment, the velocity v₂ is from about 10 m/s to about 200 m/s. The velocity v₂ can also be from about 30 m/s to about 175 m/s.

According to another embodiment, the system is such that air is supplied with a molar flow rate F₁, hydrogen is supplied with a molar flow rate F₂ and the ratio F₂/F₁ is comprised between about 1.2 and about 3.5. According to another embodiment, the ratio F₂/F₁ can be comprised between about 2 and about 3.5. The ratio F₂/F₁ can also be comprised between about 2.8 and about 3.5.

According to another embodiment, the system is such that the length L of the reaction chamber is such that the reaction chamber volume allows a minimal residence time of air and hydrogen, inside the reaction chamber. According to another embodiment, the residence time is from 0.001 to 1 second. The residence time can also be from 0.01 to 0.1 second.

According to another embodiment, the system is designed to maintain the reaction chamber at an average temperature T comprised between about 500° C. and about 1500° C. during the combustion.

According to another embodiment, the system is designed to maintain a temperature T₁ comprised between about 600° C. and about 1500° C. in a first region of the reaction chamber where the flows of gas mix.

According to another embodiment, the system is designed to maintain a temperature T₂ comprised between about 500° C. and about 1500° C. in a second region near an outlet of the reaction chamber. According to another embodiment, the temperature T₂ is comprised between about 500° C. and about 1200° C.

According to another embodiment, the system is such that the wall of the reaction chamber comprises a non-thermally insulating material to allow maintain the temperature in the reaction chamber at least in part by dissipating heat generated by the combustion to the outside of the reaction chamber. According to another embodiment, the non-thermally insulating material is a metallic material.

According to another embodiment, the system further comprises a device in which circulates a heat transfer fluid to recover the dissipated heat. According to another embodiment, the heat transfer fluid is a liquid, an oil or a gas. According to another embodiment, the heat transfer fluid is water of suitable quality for generating superheated steam. According to another embodiment, the generated steam is recycled to provide at least in part the heat required in the process or in another process or to generate electricity. According to another embodiment, the dissipation of heat is performed by convection, in the presence of air.

According to another embodiment, the system is such that the pressure in the reaction chamber is at least 1 atm. According to another embodiment, the pressure in the reaction chamber is from 1 atm to about 10 atm.

According to another embodiment, the system is such that the first means for supplying the air flow comprises a tube having an outer diameter and an outer wall, the air flowing through the tube from a first end to a second end.

According to another embodiment, the system is such that the second end of the tube through which the air flow enters the reaction chamber is located at the level of the first end of the reaction chamber.

According to another embodiment, the system is such that the second means for supplying the hydrogen flow comprises a space defined by the outer diameter of the tube for supplying the air flow and extending perpendicularly from the outer wall of the tube to the inner wall of the reaction chamber.

According to another embodiment, the system is such that the reaction chamber is cylindrical in shape and the second means for supplying the hydrogen flow comprises an annular space delimited by the outer diameter of the tube for supplying the air flow and extending perpendicularly from the outer wall of the tube to the inner wall of the reaction chamber.

According to another embodiment, the system is such that:
the first means for supplying the air flow comprises a first tube having an outer diameter and an outer wall, the air flowing through the first tube from a first end of the first tube to a second end of the first tube, and
the second means for supplying the hydrogen flow comprises a second tube having an inner diameter and an inner wall, the hydrogen flowing through the second tube from a first end of the second tube to a second end of the second tube

According to another embodiment, the system is such that the second end of the first tube through which air enters the reaction chamber and the second end of the second tube through which hydrogen enters the reaction chamber are both located at the first end of the reaction chamber.

According to another embodiment, the system is such that the hydrogen flow is supplied to the reaction chamber through a space delimited by the outer diameter of the first tube and extending perpendicularly from the outer wall of the first tube to the inner wall of the second tube.

According to another embodiment, the system is such that the reaction chamber is cylindrical in shape and the hydrogen flow is supplied to the reaction chamber through an annular space delimited by the outer diameter of the first tube and extending perpendicularly from the outer wall of the first tube to the inner wall of the second tube.

According to another embodiment, the system is such that the hydrogen comes from a water electrolysis reaction.

According to another embodiment, the system further comprises a device for drying the produced gas comprising (N₂) and hydrogen (H₂) and for recovering water.

According to another embodiment, the device for drying and for recovering water comprises a cooling condensation unit.

### BRIEF DESCRIPTION OF THE FIGURES

FIG. 1 shows a schematic vertical cross-sectional view of a reactor which can be used to carry out the process according to one embodiment.

FIG. 2 shows a schematic vertical cross-sectional view of a reactor which can be used to carry out the process according to another embodiment.

FIG. 3 shows a schematic vertical cross-sectional view of a system comprising several reactors according to FIG. 1 which can be used to carry out the process according to another embodiment.

FIG. 4 shows a schematic vertical cross-sectional view of a system comprising several reactors according to FIG. 2 which can be used to carry out the process according to another embodiment.

FIG. 5 shows a schematic vertical cross-sectional view of a reactor which can be used to carry out the process according to yet another embodiment.

### DETAILED DESCRIPTION

All technical and scientific terms and expressions used herein have the same meanings as those generally understood by the person skilled in the art of the present technology. The definition of certain terms and expressions used are nevertheless provided below.

The term “about” as used in the present document means approximately, in the region of, and around. When the term “about” is used in connection with a numerical value, it modifies it, for example, above and below by a variation of 10% compared to the nominal value. This term can also take into account, for instance, the experimental error of a measuring device or the rounding of a value.

When an interval of values is mentioned in the present application, the lower and upper limits of the interval are, unless otherwise indicated, always included in the definition. So when a range of values is indicated as “between X and Y” or “between about X and about Y”, the values X and Y are included in the definition.

In the present description, the term “synthesis gas” is used to identify a gas mixture comprising at least hydrogen (H₂) and nitrogen (N₂). In some embodiments, the synthesis gas may comprise water vapor (H₂₀).

The term “flow” is used to describe the various gas flows that are involved in carrying out the synthesis gas production reaction, inside the reaction chamber. As will be described in more detail below, the reaction involves a flow containing hydrogen (H₂) and an air flow containing oxygen (02) and nitrogen (N₂) which are going to react to form the synthesis gas.

The present document therefore presents an innovative process and system for producing a gas comprising nitrogen (N₂) and hydrogen (H₂) in a reaction chamber of a reactor. The process comprises injecting air and injecting hydrogen into the reactor, and the combustion of a portion of the injected hydrogen with oxygen from the air in the reaction chamber. The reaction takes place in the presence of an overstoichiometric molar excess of hydrogen relative to the oxygen in the air. The combustion in the reaction chamber is supported by a flame produced by a flow of air having a velocity v₁ resulting from the injection of air, surrounded by a flow of hydrogen having a velocity v₂ resulting from the injection of hydrogen, with the velocity v₂ being greater than the velocity v₁.

The reaction to form the gas is therefore carried out in the presence of an overstoichiometric molar excess of hydrogen relative to the oxygen in the air. By “overstoichiometric molar excess of hydrogen”, one understands that the quantity of hydrogen (H₂) injected into the reactor must be sufficient on one hand to enable the combustion reaction with the oxygen from the air according to equation (2), consuming all the oxygen injected, and on another hand to ensure that a portion of the hydrogen injected is not burned and can be found in the synthesis gas produced. Thus, an overstoichiometric molar excess of hydrogen relative to oxygen implies a H₂ to 02 molar ratio necessarily greater than 2, preferably at least 5.8. According to some embodiments, the H₂ to 02 molar ratio is at most 16.7.

Combustion of hydrogen in the presence of the overstoichiometric excess of hydrogen is therefore achieved with a flame that is produced by the air flow surrounded by the hydrogen flow, in the reaction chamber. Combustion can be initiated using an ignition device, such as an electric arc, an incandescent wire, a spark plug or any other known energy source. In the reaction chamber, the air flow, and therefore the flame, is thus enclosed in a kind of envelope formed by the hydrogen flow. This envelope of hydrogen around the air flow can be formed thanks to i) the difference in velocity of the air and hydrogen flows entering the reaction chamber, the velocity v₂ of the hydrogen flow being greater than the velocity v₁ of the air flow, and ii) the geometry of the inlet of the gases, i.e., air and hydrogen, into the reaction chamber.

A more detailed description of some particular embodiments of the process and the system in which it can be implemented will now be provided with reference to the figures.

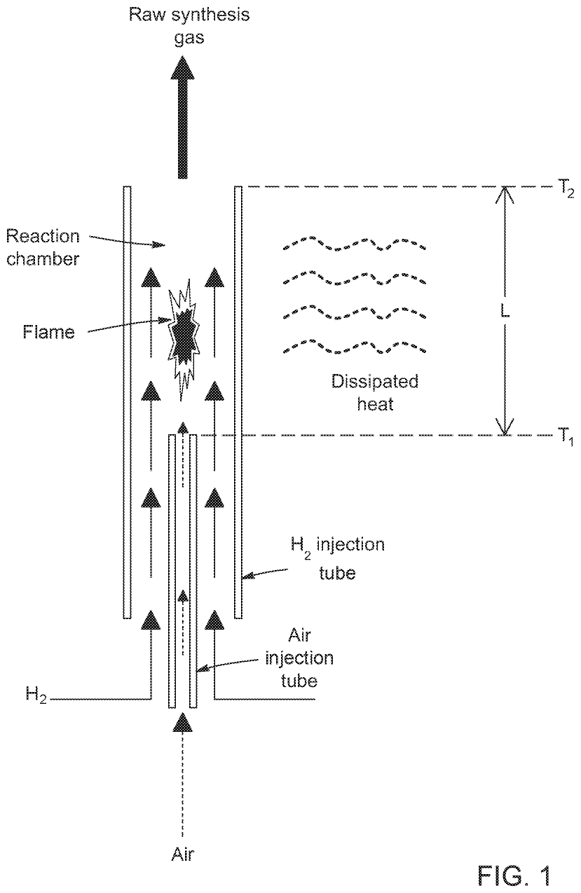

FIG. 1 shows the general operating principle of a reactor that can be used to produce the synthesis gas based on hydrogen and nitrogen in certain embodiments. The reactor can comprise at least one reaction chamber of length L provided with a wall, at least one first means for supplying air and at least one second means for supplying hydrogen. The first and second means for supplying the reaction chamber with the air flow and the hydrogen flow are located at a first end of the chamber, which, in FIG. 1, is at the bottom of the reaction chamber. In addition, the means for supplying the hydrogen and air flows are arranged to enable the air flow to be surrounded by the hydrogen flow during combustion, i.e., to enable the hydrogen flow to form an envelope around the air flow. In this way, the arrangement of the means for supplying the air and hydrogen flows provides a central air flow with the surrounding hydrogen flow in the reaction chamber.

According to some embodiments, the first means for supplying the air flow can comprise a tube having an outer diameter and an outer wall, the air flowing through the tube from a first end to a second end. According to one embodiment, the second end of the tube through which the air flow enters the reaction chamber can be located approximately at the level of the first end of the reaction chamber. In another embodiment, the second end of the tube through which the air flow enters the reaction chamber can be located within the first third of the height of the reaction chamber starting from the first end of the chamber. The second means for supplying the hydrogen flow can comprise a space defined by the outer diameter of the tube for supplying the air flow and extending perpendicularly from the outer wall of the tube to the inner wall of the reaction chamber.

According to another possible arrangement, the reaction chamber can be cylindrical in shape and the second means for supplying the hydrogen flow can comprise an annular space delimited by the outer diameter of the tube for supplying the air flow and extending perpendicularly from the outer wall of the tube to the inner wall of the reaction chamber.

In one embodiment, the reactor itself can consist of two concentric tubes forming an arrangement as shown more particularly in FIG. 1. In the tube arrangement shown in FIG. 1, the outer tube both forms the wall of the reaction chamber and delimits the annular space through which the hydrogen flow is fed. The inner tube is used to inject air, and the space extending from the outer wall of the inner tube to the inner wall of the outer tube forms the annular space for supplying the hydrogen flow.

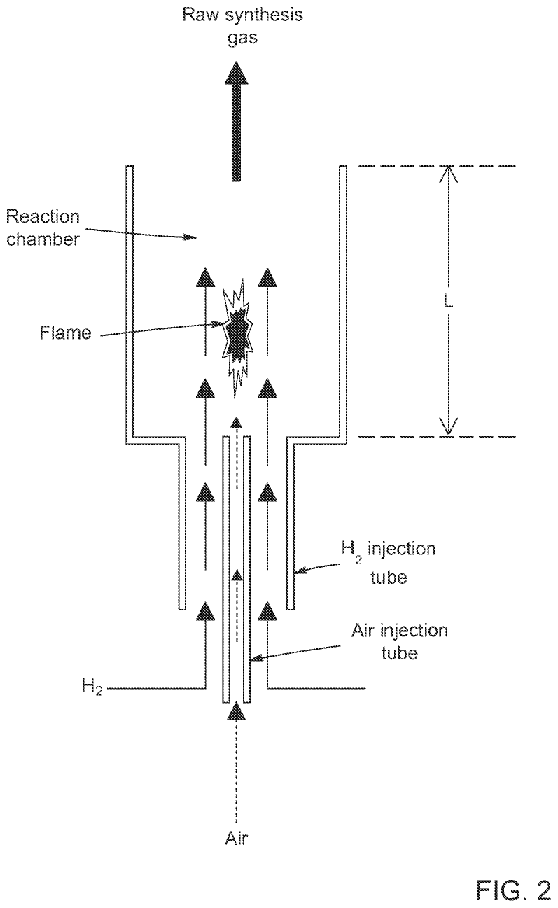

In a further embodiment, the reactor itself can consist of three tubes forming an arrangement as shown more particularly in FIG. 2. According to this embodiment, the reactor can comprise a first tube for air injection, a second tube for H₂ injection, and finally, a third tube defining the reaction chamber wall. In the arrangement shown in FIG. 2, hydrogen is injected into the annular space defined by the outer diameter of the air injection tube and the inner diameter of the hydrogen injection tube. As shown in FIG. 2, the upper end of the hydrogen injection tube terminates at the lower end of the tube defining the reaction chamber wall. As also shown in FIG. 2, the upper ends of the air injection and hydrogen injection tubes can be substantially aligned, with the air and hydrogen flows entering the reaction chamber at the same level.

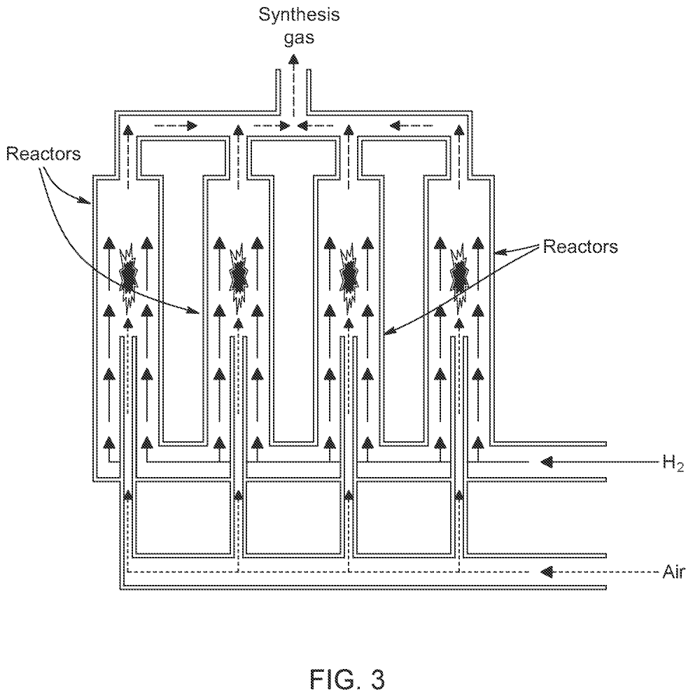

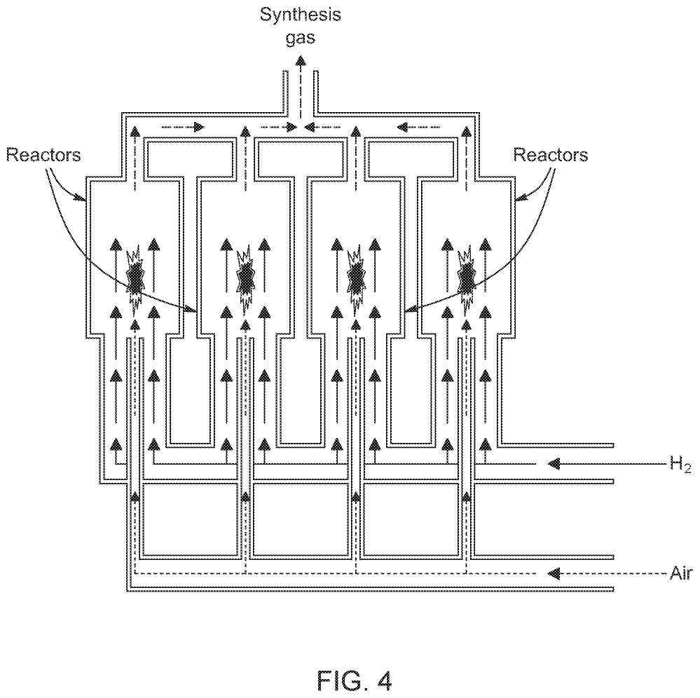

According to one embodiment, the system for producing the synthesis gas based on nitrogen and hydrogen, according to the present technology, can comprise a plurality of reactors in parallel as shown, for example, in FIGS. 3 and 4. Thus, the system can comprise an enclosure containing a multitude of reactors where each reactor, which can be of the type shown in FIG. 1 or of the type shown in FIG. 2, receives a flow of air and a flow of hydrogen. Air on the one hand and hydrogen on the other can be supplied to the system by means of a common inlet for each gas. Each gas is then fed into each reactor. The synthesis gas produced in each reactor can then be assembled and discharged from the system via a common outlet.

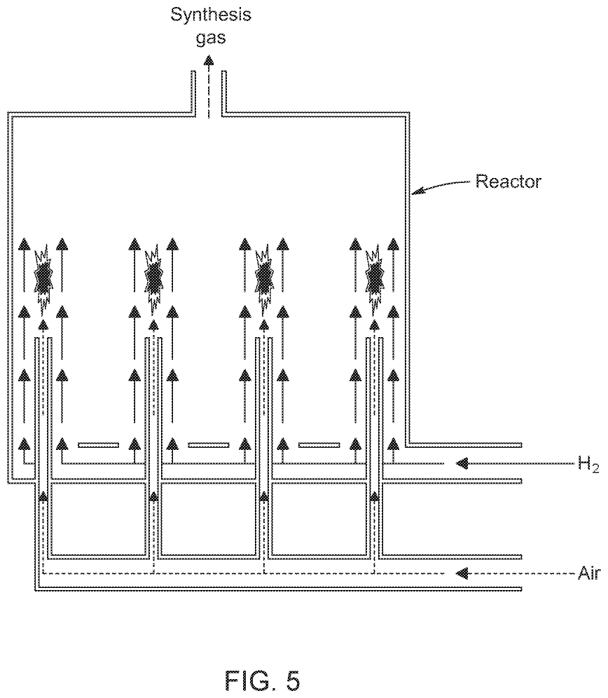

In a further embodiment, the system for producing the synthesis gas based on nitrogen and hydrogen, according to the present technology, can comprise a reactor as shown in FIG. 5 designed to produce a plurality of combustion reactions of hydrogen by oxygen from air, in the presence of an overstoichiometric excess, within a single reaction chamber. Thus, the reactor can be arranged to receive a main flow of air and a main flow of hydrogen, each of the main flows separating into several secondary flows. For each combination of secondary air and hydrogen flows entering the reaction chamber, the velocity v₁ of the secondary air flow is lower than the velocity v₂ of the secondary hydrogen flow. Thus, in the reaction chamber, each secondary air flow ends up in a kind of envelope formed by the associated secondary hydrogen flow. The flame produced by each combination of secondary air and hydrogen flows is also enveloped by the associated secondary hydrogen air flow. The synthesis gas produced for each combination of secondary air and hydrogen flows can be recovered in a global synthesis gas stream at the reactor outlet.

According to one embodiment, a reactor for producing the synthesis gas is designed so that the temperature in the reaction chamber of the reactor is maintained at a certain level in order to limit NOx production. Thus, according to some embodiments, the system is designed to maintain the reaction chamber at an average temperature T of between about 500° C. and about 1500° C. during combustion. The average temperature T in the reaction chamber during combustion can, for example, be maintained at about 500° C., 600° C., 700° C., 800° C., 900° C., 1000° C., 1100° C., 1200° C., 1300° C., 1400° C. or 1500° C., or can be any value comprised between these temperatures. Furthermore, it is possible in some embodiments to control the temperature in the regions at the ends of the reaction chamber to maintain a certain temperature there. For example, the system can be designed to maintain a temperature T₁ in a region near the entrance to the reaction chamber where the gas flows mix, of between about 600° C. and about 1500° C. The temperature T₁ can therefore be maintained at about 600° C., 700° C., 800° C., 900° C., 1000° C., 1100° C., 1200° C., 1300° C., 1400° C. or 1500° C., or at any value comprised between these temperatures. In other embodiments, the system can be designed to maintain a temperature T₂ in a region near the reaction chamber outlet of between about 500° C. and about 1500° C. In some cases, the temperature T₂ in the region near the reaction chamber outlet can be controlled to be comprised between about 500° C. and about 1200° C. The temperature T₂ can therefore be maintained at about 500° C., 600° C., 700° C., 800° C., 900° C., 1000° C., 1100° C., 1200° C., 1300° C., 1400° C. or 1500° C. or any value comprised between these temperatures. Temperature control can be carried out in a number of different ways, details of which are given below. It should also be noted that the temperature of the reaction chamber as mentioned above can vary depending on the exact location where the temperature measurement is taken. Furthermore, it should be noted that the temperature values mentioned above can be different than the maximum temperature of the reaction itself, which can reach temperatures above 1500° C. Indeed, the temperature at the level of the hydrogen-oxygen flame can even reach values of more than 2000° C.

According to some embodiments, in addition to controlling and maintaining a certain temperature in the reaction chamber, it is possible to control the pressure to facilitate combustion. According to embodiments, the pressure in the reaction chamber is controlled to be at least 1 atm. The pressure in the reaction chamber can, for example, vary between about 1 atm and 10 atm. Thus, the pressure can be 1 atm, 2 atm, 3 atm, 4 atm, 5 atm, 6 atm, 7 atm, 8 atm, 9 atm, 10 atm or any pressure between these values.

As mentioned previously, the air flow and the hydrogen flow must have different velocities within the reaction chamber, with the velocity of the hydrogen flow being greater than that of the air flow. In some embodiments, air is injected into the reactor so as to form a central flow inside the reaction chamber at velocity v₁. This velocity v₁ is calculated from the volumetric flow rate of supplied air corrected to the temperature T₁ and pressure in the reaction chamber, this flow rate being divided by the surface area perpendicular to the flow of the air injection tubing. According to some embodiments, the velocity v₁ can be from about 1 m/s to about 200 m/s. For example, velocity v₁ can be from about 5 m/s to about 150 m/s, or from about 10 m/s to about 100 m/s. Thus, the velocity v₁ of the central air flow can be 1 m/s, 5 m/s, 10 m/s, 20 m/s, 30 m/s, 40 m/s, 50 m/s, 60 m/s, 70 m/s, 80 m/s, 90 m/s, 100 m/s, 110 m/s, 120 m/s, 130 m/s, 140 m/s, 150 m/s, 160 m/s, 170 m/s, 180 m/s, 190 m/s, 200 m/s, or any velocity between these values.

According to some embodiments, the velocity v₂ can be from about 2 m/s to about 220 m/s. For example, the velocity v₂ can be from about 10 m/s to about 200 m/s, or from about 15 m/s to about 175 m/s. Thus, the velocity v₂ of the hydrogen flow can be 2 m/s, 5 m/s, 10 m/s, 20 m/s, 30 m/s, 40 m/s, 50 m/s, 60 m/s, 70 m/s, 80 m/s, 90 m/s, 100 m/s, 110 m/s, 120 m/s, 130 m/s, 140 m/s, 150 m/s, 160 m/s, 170 m/s, 180 m/s, 190 m/s, 200 m/s, 210 m/s, 220 m/s or any velocity between these values as long as it is greater than the air flow velocity v₁.

As shown in FIG. 1 and previously explained, according to one embodiment, hydrogen can be fed into the reactor in the space formed between the outer wall of the tube for supplying air and the inner wall of the reactor, this space being annular, for example, when the reactor wall is cylindrical. In this way, the hydrogen injected into the reaction chamber constitutes a hydrogen flow whose velocity v₂ must be greater than that of the air flow (v₁). The velocity v₂ of the hydrogen flow entering the reaction chamber is calculated from the volumetric flow rate of injected hydrogen corrected to the temperature T₁ and pressure in the reactor, this flow rate being divided by the surface area perpendicular to the flow of the space where the injected hydrogen circulates, this space being preferably annular as explained above.

As shown in FIG. 2 and explained previously, according to another embodiment, hydrogen is fed into the reactor by injection into the space formed between the outer wall of the tube for supplying air and the inner wall of the tube for supplying hydrogen, this space being annular, for example, when the wall of the tube for supplying hydrogen is cylindrical in shape. In this way, the hydrogen injected into the reaction chamber constitutes a hydrogen flow whose velocity v₂ must be greater than that of the air flow (v₁). The velocity v₂ of the hydrogen flow entering the reaction chamber is calculated from the volumetric flow rate of injected hydrogen corrected to the temperature T₁ and pressure in the reactor, this flow rate being divided by the surface area perpendicular to the flow of the space where the injected hydrogen circulates, this space being preferably annular as explained above.

Air and hydrogen are fed into the reactor at certain molar flow rates to support the combustion reaction between hydrogen and oxygen from the air, while having an overstoichiometric excess of hydrogen. According to some embodiments, air is supplied to the reactor with a molar flow rate F₁ and hydrogen is supplied with a molar flow rate F₂ and the ratio F₂/F₁ is between about 1.2 and about 3.5. According to another embodiment, the ratio between the hydrogen and air molar flow rates F₂/F₁ can be between about 2 and about 3 or can be between about 2.8 and about 3.5. The F₂/F₁ ratio can therefore be about 1.2 or 1.5 or 2 or 2.5 or 3 or 3.5 or any ratio between these values. According to some embodiments, the F₂/F₁ ratio can be about 3 and more particularly about 2.8, which corresponds to the theoretical molar ratio for producing a synthesis gas containing the proportions of H₂ and N₂ required to manufacture ammonia according to reaction (2), while allowing complete conversion, into H₂₀, of the oxygen contained in the injected air.

As previously indicated, the reaction chamber of the reactor in which the synthesis gas is produced can have a length L corresponding substantially to a distance between a region where the hydrogen flow and the air flow mix in the reaction chamber (e.g., at the lower end of the chamber) and a region close to the reaction chamber outlet at the other end of the reaction chamber (e.g., at the upper end of the chamber). The length L of the reaction chamber can be such that the volume of the reaction chamber allows a minimum residence time for air and hydrogen inside the reaction chamber.

According to one embodiment, the length L is such that the residence time t of the gases in the reaction chamber is from 0.001 to 1 second. According to another embodiment, the residence time is 0.01 to 0.1 second.

The residence time is defined as follows:

$$t = V / ( ( {Q}_{2} + {Q}_{1} ) * ( T + 2 \; 73 ) / 298 / P ) * K \qquad ( 3 )$$

where V is the volume of the reaction chamber, Q₂ is the standard volume flow rate (25° C. and 1 atm) of the H₂ supplied, Q₁ is the standard volume flow rate (25° C. and 1 atm) of the air supplied, T is the average temperature (° C.) in the reaction chamber and finally, P is the pressure (atm) inside the reactor. Finally, K is a unit constant. For each of the air and hydrogen flows, the relationship between molar flow rate and standard volume flow rate is defined, for air and hydrogen respectively, by the following equations:

$${Q}_{1} = {F}_{1} * R * ( T + 2 \; 73 ) / P \qquad ( 4 )$$

$$and$$

$${Q}_{2} = {F}_{2} * R * ( T + 2 \; 73 ) / P \qquad ( 5 )$$

where R is the gas constant.

Thus, the residence time t in the reaction chamber can be from 0.001 to 1 second. In another embodiment, the residence time t can be from 0.01 to 0.1 second. The residence time t can therefore be 0.001 or 0.002 or 0.005 or 0.01 or 0.015 or 0.02 or 0.03 or 0.04 or 0.05 or 0.06 or 0.07 or 0.08 or 0.09 or 0.1 or 0.2 or 0.3 or 0.4 or 0.5 or 0.6 or 0.7 or 0.8 or 0.9 or 1 second, or any time comprised between these values.

According to some embodiments, but not limited to these values, the length L of the reaction chamber can be comprised between approximately 0.10 m and 3 m. The length L can be determined to reach a system capacity to maintain a desired conversion efficiency.

As mentioned above, the temperature in the reaction chamber can be maintained at a certain value between a minimum temperature and a maximum temperature during combustion and production of the synthesis gas. By maintaining a certain temperature in the reaction chamber, NOx production can be limited. One way of controlling the temperature so that it remains at a certain value is to carry out combustion in a reaction chamber whose wall is made of a non-thermally insulating material. In this way, the heat released by the combustion of hydrogen by oxygen from the air in the reaction chamber can, at least in part, be dissipated through the non-insulating wall material to the outside of the reaction chamber (see FIG. 1). Such a thermally non-insulating material can be, for example, a metallic material such as a metal alloy. The material is also preferably corrosion-resistant. A metal such as Inconel® or another equivalent material can, for example, be used to form the wall of the reaction chamber.

In some embodiments, the heat released by combustion through the reaction chamber wall can be dissipated by convection, in the presence of air. In this way, air can be continuously circulated around the reactor during combustion to maintain a certain temperature in the reaction chamber. In other embodiments, the heat that is dissipated through the wall of the reaction chamber can be recovered by a device in which a heat transfer fluid circulates. A heat exchange device in which the heat transfer fluid is a liquid, oil or gas can be used. Such a device may, for example, comprise a jacket surrounding the reactor, through which the heat transfer fluid circulates. In one embodiment, the heat dissipated through the wall of the reaction chamber can be used to heat water circulating in a device surrounding the chamber so as to generate steam. Recovering the heat released by the reactor can be of particular interest for generating superheated steam with water of suitable quality circulating in the heat exchange device. Furthermore, in some embodiments, the steam thus generated can be recycled to provide at least part of the heat required in the process, in another process or to generate electricity. For example, the superheated steam produced can be used to power a steam turbine used to generate electricity.

The synthesis gas produced by the system described above and leaving the reactor therefore includes nitrogen (N₂) and hydrogen (H₂), as well as a certain water vapor content. The gas at the exit of the reactor is therefore a wet raw gas which can then be dried to recover a dry gas. The raw gas can be dried by known water vapor separation means. In some embodiments, the raw gas drying and water recovery device may comprise a cooling condensation unit. It is also possible, if required, to use other means of water vapor separation, such as an adsorption drying medium for instance. The water recovered during drying of the raw synthesis gas can then be reused in the process, as will be explained below, for example to produce the hydrogen that will be supplied to the reactor.

In the context of sustainable development, it is proposed that the hydrogen used to produce the synthesis gas be produced by a water electrolysis system powered by electricity from a renewable source (hydraulic, wind or solar). In a particular embodiment, the water electrolysis system can use electricity generated, at least in part, from superheated steam obtained by recovering the heat released by the reactor as mentioned above. In addition, the water used to obtain hydrogen by electrolysis of water can come, at least in part, from the water recovered during drying of the synthesis gas exiting the reactor, as detailed above. Alternatively, the water recovered during the drying of the synthesis gas can be used, at least in part, as a heat transfer fluid in the device for recovering the heat released by the reactor, as explained above.

The synthesis gas obtained by the present technology, which comprises nitrogen and hydrogen, can be used in various industrial processes for which these two gases are required. Although such an industrial process preferably comprises the production of ammonia, other industrial processes using H₂/N₂ mixtures with molar ratios different from that required for ammonia synthesis can also use the synthesis gas produced by the present technology.

To obtain a synthesis gas intended for use in ammonia production, the ratio between the molar flow rate of injected hydrogen and the molar flow rate of injected air can preferably be between 2.8 and 3.5, more particularly around 3, more particularly around 2.8. When using a ratio between the molar flow rate of hydrogen injected and the molar flow rate of air injected of 2.8, it is therefore expected to obtain, using the present technology, a synthesis gas with the following molar composition at the reactor outlet:
N₂: 22.0%
H₂: 66.3%
H₂O: 11.7%
NOx: trace.

It should be noted that, although it is preferable to feed the reactor using an H₂/air molar ratio of between 2.8 and 3.5, to produce a synthesis gas that can be used directly for ammonia production, it is also absolutely possible to use an H₂/air ratio of less than 2.8, as long as the hydrogen is injected in an overstoichiometric excess compared to the oxygen from the air. Thus, one will obtain a synthesis gas with a H₂/N₂ molar ratio lower than the H₂/N₂ molar ratio required for direct ammonia synthesis, but it will suffice to add the necessary amount of hydrogen (e.g., electrolytic hydrogen) to adjust the H₂/N₂ ratio.

The technology described herein has several advantages. It offers a process that is easy to implement and relatively inexpensive for producing synthesis gas based on hydrogen and nitrogen, notably a synthesis gas that can be used to synthesize ammonia. The production of synthesis gas according to the present technology is therefore conducive to a process to produce “green” ammonia, i.e., ammonia production with a lifecycle that is free of—or virtually free of—greenhouse gas (GHG) emissions.

### Example

A small-scale reactor was built so as to define an arrangement as shown in FIG. 2. This reactor was constructed from Inconel 600™ tubes. For each of the tubes, one has the following dimensions:
Air injection tube: O.D.=6.39 mm, I.D.=4.12 mm
H₂ injection tube: O.D.=12.7 mm, I.D.=8.75 mm
Outer tube: O.D.=19.05 mm, I.D.=13.71 mm
   with I.D.=inner diameter and O.D.=outer diameter.

The outer tube defines the wall of the reaction chamber of the reactor, with a length L=347 mm. Based on the inner diameter of the outer tube and this length L, this gives an inner volume V equal to 51.29 cm³.

A first thermocouple, located at a vertical distance of 32.37 mm from the nozzle, allows to measure a proximity temperature level, i.e., T₁. A second thermocouple, located near the reactor outlet, at a vertical distance of around 340 mm from the nozzle, allows to measure the temperature level T₂. The NO content is measured directly and continuously, using a dedicated analyser. The part of the gas leaving the reactor and which is circulating into the analyzer is at a temperature of around 28° C. NO is considered representative of nitrogen oxides.

A series of tests was carried out, varying the air and H₂ flow rates (Q₁ and Q₂ respectively). The table below presents the main results obtained for 9 tests. For these tests, the flow rates Q₁ and Q₂ are varied, while maintaining a Q₂/Q₁ ratio always equal to 3.50. This produces a synthesis gas based on N₂ and H₂, for which the H₂/N₂ molar ratio is equal to 3.90.

The air flow velocity v₁ is calculated from the perpendicular surface defined by the inner diameter of the air injection tube and from the volume flow rate of air corrected at a temperature T₁ and the pressure in the reaction chamber. The H₂ flow velocity (v₂) is calculated from the surface area of the annular space delimited by the inner diameter of the hydrogen injection tube and the outer diameter of the air injection tube, and from the volume flow rate of H₂ corrected to a temperature T₁ and the pressure in the reaction chamber.

The residence time t in the reactor is calculated from the volume of the reaction chamber divided by the sum of the volume flow rates Q₁+Q₂ (which are standard flow rates at 25° C. (298 K) and 1 atm), considering an average temperature (T₁+T₂)/2 and considering the pressure level P in the reactor (1 atm), according to the following equation:

$$t = V / ( ( {Q}_{1} + {Q}_{2} ) * 1000 / 60 * ( ( {T}_{1} + {T}_{2} ) / 2 + 273 ) / 298 / P$$

| Q₂ | Q₁ | | | | | | | |
|---|---|---|---|---|---|---|---|---|
| (sL/ | (sL/ | T₁ | T₂ | T_{moy} | NO | v₂ | v₁ | t |
| min) | min) | (° C.) | (° C.) | (° C.) | (ppm) | (m/s) | (m/s) | (s) |
| 10 | 2.86 | 875 | 85 | 480 | 10.79 | 22.9 | 13.8 | 0.0947 |
| 11 | 3.14 | 917 | 100 | 509 | 9.78 | 26.1 | 15.7 | 0.0830 |
| 12 | 3.42 | 956 | 117 | 537 | 9.96 | 29.4 | 17.6 | 0.0735 |
| 13 | 3.71 | 992 | 135 | 564 | 9.02 | 32.8 | 19.7 | 0.0656 |
| 14 | 4 | 1035 | 151 | 593 | 11.21 | 36.5 | 21.9 | 0.0588 |
| 15 | 4.29 | 1076 | 169 | 623 | 10.69 | 40.3 | 24.3 | 0.0531 |
| 16 | 4.57 | 1109 | 185 | 647 | 10.75 | 44.1 | 26.5 | 0.0485 |
| 17 | 4.86 | 1135 | 201 | 668 | 11.3 | 47.7 | 28.7 | 0.0446 |
| 18 | 5.14 | 1158 | 217 | 688 | 11.34 | 51.3 | 30.9 | 0.0413 |

As shown in the table, the NO content of the gas obtained in each test did not vary significantly. A statistical analysis gives a mean value of 10.54 ppm with a confidence interval of +/−0.61 ppm (based on Student's ratio for 95% probability). Increasing the flow rate of the inputs (Q₁ and Q₂) causes the residence time to vary from 0.095 to 0.041 second, but has no significant effect on the NO content of the exiting gas.

Although certain embodiments of the technology have been described above, the technology is not limited to these sole embodiments. Several modifications could be made to one or the other of the embodiments described above, without departing from the scope of the present technology.

What is claimed is:

1- Process for producing a gas comprising nitrogen (N₂) and hydrogen (H₂) in a reaction chamber of length L of a reactor, comprising injecting air and injecting hydrogen into the reactor and combusting a portion of the injected hydrogen with the oxygen from the air in the reaction chamber in the presence of an overstoichiometric molar excess of hydrogen relative to the oxygen from the air, wherein:
the combustion is supported by a flame produced by an air flow having a velocity v₁ resulting from the injection of air, surrounded by a hydrogen flow having a velocity v₂ resulting from the injection of hydrogen, with the velocity v₂ being greater than v₁.

2- The process according to claim 1, wherein the velocity v₁ is from about 1 m/s to about 200 m/s.

3-4- (canceled)

5- The process according to claim 1, wherein the velocity v₂ is from about 2 m/s to about 220 m/s.

6- The process according to claim 1, wherein the velocity v₁ is from about 5 m/s to about 150 m/s and the velocity v₂ is from about 10 m/s to about 200 m/s.

7- The process according to claim 1, wherein the velocity v₁ is from about 10 m/s to about 100 m/s and the velocity v₂ is from about 15 m/s to about 175 m/s.

8- The process according to claim 1, wherein air is injected with a molar flow rate F₁, hydrogen is injected with a molar flow rate F₂, and the ratio F₂/F₁ is comprised between about 1.2 and about 3.5.

9- The process according to claim 8, wherein the ratio F₂/F₁ is comprised between about 2 and about 3.5.

10- The process according to claim 8, wherein the ratio F₂/F₁ is comprised between about 2.8 and about 3.5.

11- The process according to claim 1, wherein the length L of the reaction chamber is such that the reaction chamber volume allows a minimal residence time of air and hydrogen, inside the reaction chamber.

12- The process according to claim 11, wherein the residence time is from 0.001 to 1 second.

13- (canceled)

14- The process according to claim 1, wherein the reaction chamber is maintained at an average temperature T comprised between about 500° C. and about 1500° C. during the combustion.

15- The process according to claim 1, wherein the reaction chamber is maintained at a temperature T₁ in a first region where the flows of air and hydrogen mix in the reaction chamber, with T₁ comprised between about 600° C. and about 1500° C. and the reaction chamber is maintained at a temperature T₂ in a second region near an outlet of the reaction chamber, with T₂ comprises between about 500° C. and about 1500° C.

16-17- (canceled)

18- The process according to claim 14, wherein the temperature is maintained in the reaction chamber at least in part by dissipating heat generated by the flame to the outside of the reaction chamber.

19- The process according to claim 14, wherein the temperature is maintained in the reaction chamber at least in part by recovery of heat generated by the flame, by a heat transfer fluid.

20- (canceled)

21- The process according to claim 19, wherein the heat transfer fluid is water of suitable quality for generating superheated steam and the generated steam is recycled to provide at least in part the heat required in the process or in another process or to generate electricity.

22- (canceled)

23- The process according to claim 18, wherein the dissipation of heat is performed by convection, in the presence of air.

24- The process according to claim 1, wherein the pressure in the reaction chamber is at least 1 atm.

25- The process according to claim 1, wherein the pressure in the reaction chamber is from 1 atm to about 10 atm.

26- The process according t wherein hydrogen comes from a water electrolysis reaction.

27-29- (canceled)

30- A system comprising at least one reactor to produce a gas comprising nitrogen (N₂) and hydrogen (H₂), wherein said reactor comprises:
a reaction chamber comprising a wall and a first end and a second end separated by a distance L, wherein the gas is produced by combusting a portion of injected hydrogen with oxygen from air in the presence of an overstoichiometric molar excess of hydrogen relative to the oxygen from the air;
at least one first means for supplying the reaction chamber with an air flow at a velocity v₁ at the first end of the chamber;
at least one second means for supplying the reaction chamber with a hydrogen flow at a velocity v₂ at the first end of the chamber, the velocity v₂ being greater than v₁;
the first means supplying the air flow and the second means supplying the hydrogen flow are arranged so that the air flow is surrounded by the hydrogen flow during the combustion.

31-66- (canceled)
